(19) United States
(12) Patent Application Publication
(10) Pub. No.: US 2010/0109172 A1
(43) Pub. Date: May 6, 2010

(54) MOLD FOR MAKING LENS ARRAY AND METHOD FOR MAKING LENSES

(75) Inventors: Ga-Lane Chen, Santa Clara, CA (US); Han-Lung Lee, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/471,485

(22) Filed: May 26, 2009

(30) Foreign Application Priority Data
Oct. 31, 2008 (CN) 200810305338.2

(51) Int. Cl. B29D 11/00; B28B 7/00

(52) U.S. Cl. 264/1.1; 425/346

(57) ABSTRACT

An exemplary mold for molding a lens array includes a first mold core having a first molding surface and a second mold core having a second molding surface. The first and second molding surfaces each include spaced first and third molding portions arranged in an array and second and fourth molding portions, respectively. The first molding portions are interconnected by the second molding portions. The third molding portions are interconnected by the fourth molding portions. When the first mold core and the second mold core are in a ready position, a chamber is defined between the first molding surface and the second molding surface by having a space being maintained between each the first molding portion and the third molding portion and having a space being maintained between each the second molding portion and the fourth molding portion.

### BACKGROUND

1. Technical Field

The present invention relates to molds, and particularly, to a mold for molding a lens array and a method for making a plurality of lenses using the mold.

2. Description of Related Art

Currently, camera modules are widely applied in a variety of portable electronic devices, such as mobile phones. A camera module contains one or more lenses. Most portable electronic devices are becoming progressively miniaturized over time. Thus camera modules, and the lenses thereof, are correspondingly becoming smaller and smaller. Such lenses are typically also lightweight.

Injection molding has been a common method used for making lenses. Typically, chambers for molding lenses are radially arranged in a mold. All of the chambers are connected by runners to a sprue, which is in a center of the mold. With this arrangement, the number of chambers is limited, and thus the number of the lenses that can be made in a single molding cycle is also limited.

What is needed, therefore, is a mold and a method for making lenses using the mold, which can overcome the above-described shortcomings.

### BRIEF DESCRIPTION OF THE DRAWINGS

Many aspects of the present mold and method can be better understood with reference to the following drawings. The components in the drawings are not necessarily drawn to scale, the emphasis instead being placed upon clearly illustrating the principles of the present mold and method. Moreover, in the drawings, like reference numerals designate corresponding parts throughout the several views.

FIG. 1 is a cross-sectional view of part of a mold in accordance with an exemplary embodiment, the mold including a first mold core and a second mold core, the first mold core and the second mold core being in a position ready for molding. FIG. 2 is a bottom plan view of the first mold core of FIG. 1.

FIG. 3 is a cross-sectional view of the first mold core shown in FIG. 2, taken along a line III-III thereof.

FIG. 4 is a top plan view of the second mold core of FIG. 1.

FIG. 5 is a cross-sectional view of the second mold core shown in FIG. 4, taken along a line V-V thereof.

FIG. 6 is similar to FIG. 1, but showing a lens array made in the mold.

### DETAILED DESCRIPTION OF EMBODIMENTS

Embodiments of the present mold and method will now be described in detail below and with reference to the drawings.

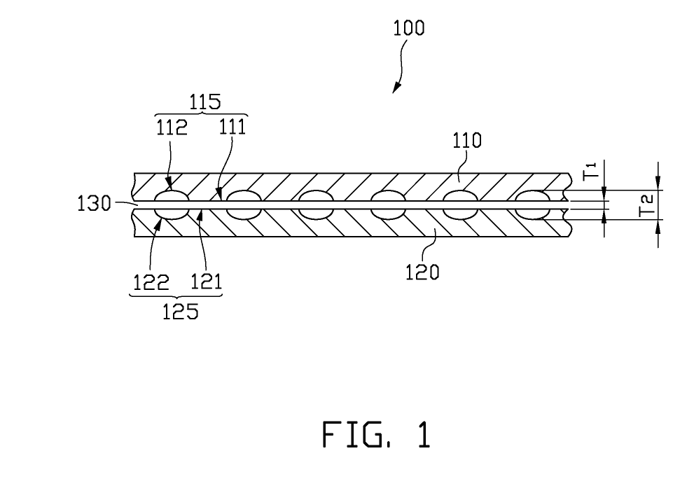

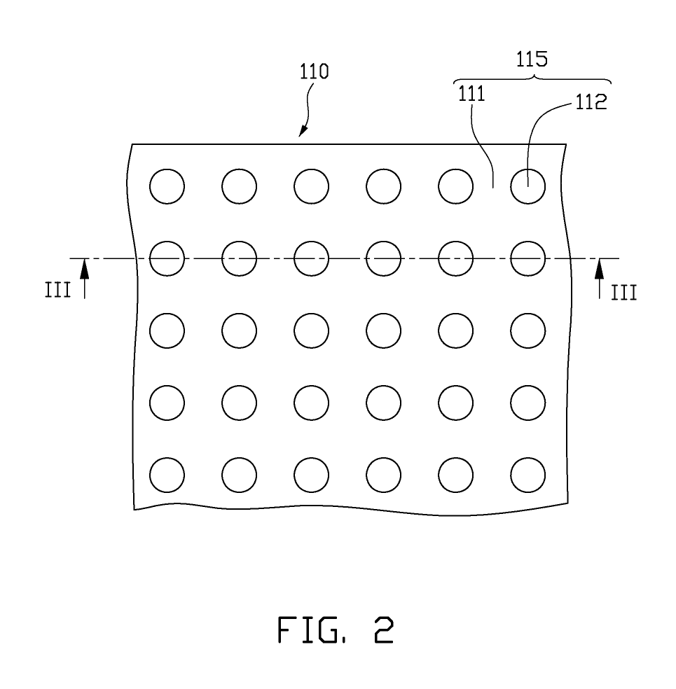

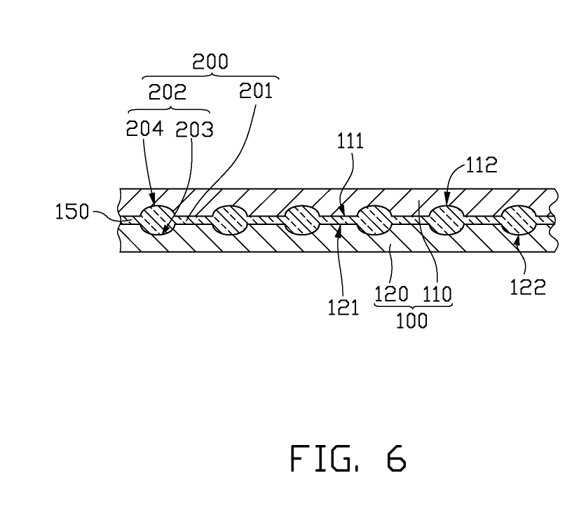

Referring to FIGS. 1 and 6, an exemplary mold 100 for molding a lens array 150 is shown. The mold 100 includes a first mold core 110 and a second mold core 120. The first mold core 110 and the second mold core 120 are shown in a position ready for molding, and cooperatively define a chamber 130 therebetween in such position. The first mold core 110 has a first molding surface 115 facing toward the second mold core 120. The second mold core 120 has a second molding surface 125 facing toward the first mold core 110. The chamber 130 is defined between the first molding surface 115 and the second molding surface 125.

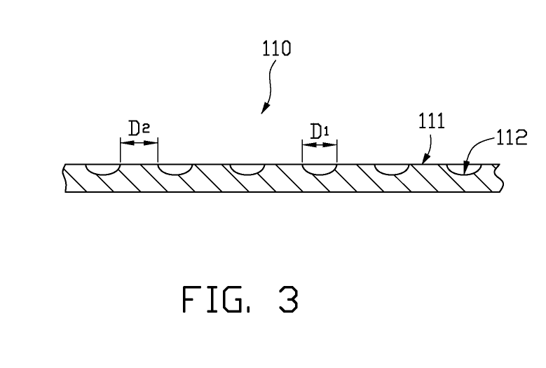

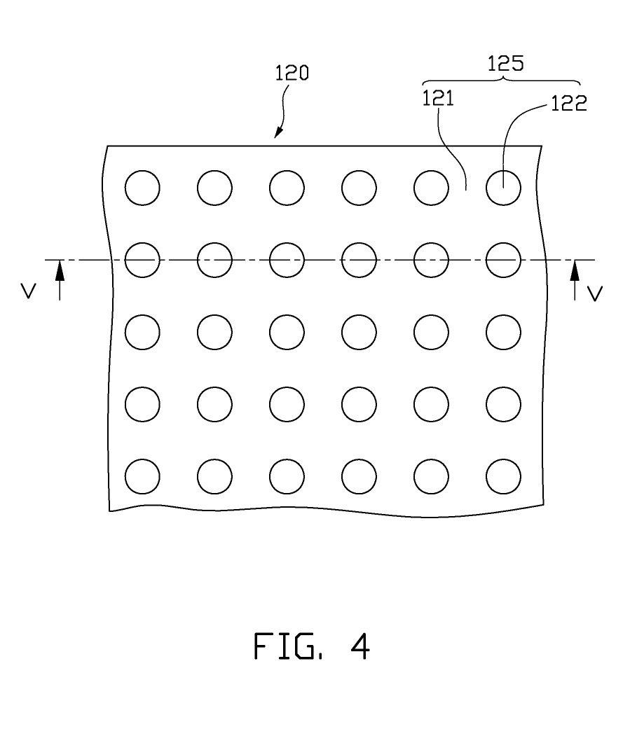

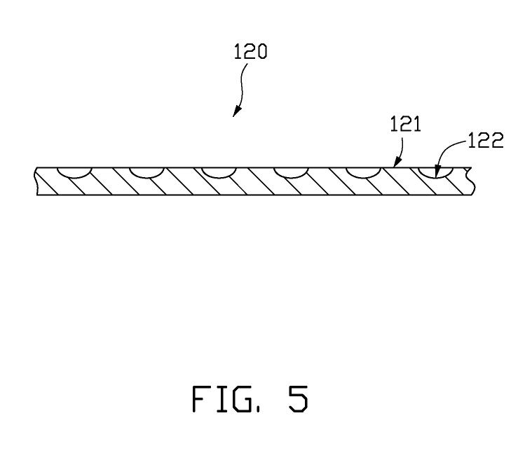

Referring also to FIGS. 2 to 5, an area of each of the first molding surface 115 and the second molding surface 125 closely relates to the number of lenses 200 in the lens array 150 (see FIG. 6). The first molding surface 115 and the second molding surface 125 are each generally rectangular-shaped. The first molding surface 115 is comprised of an array of spaced first molding portions 112, and a plurality of second molding portions 111 interconnecting all the first molding portions 112. In the illustrated embodiment, the array is in the form of a regular matrix of rows and columns. The second molding portions 111 are interconnected, thereby cooperatively constituting a single, continuous surface. The second molding surface 125 is comprised of an array of spaced third molding portions 122, and a plurality of fourth molding portions 121 interconnecting all of the third molding portions 122. In the illustrated embodiment, the array is in the form of a regular matrix of rows and columns, corresponding to the array of first molding portions 112. The fourth molding portions 121 are interconnected, thereby cooperatively constituting a single, continuous surface. The first and third molding portions 112, 122 are each concave surfaces. In other embodiments, the first and third molding portions 112, 122 can be any desired arrangement or combination of concave surfaces and convex surfaces. The second and fourth molding portions 111, 121 are flat surfaces.

In a ready position (molding position), the third molding portions 122 align with the first molding portions 112, and the fourth molding portions 121 align with the second molding portions 111. A maximum space T2 is maintained between each first molding portion 112 and the corresponding third molding portion 122, and a space T1 is maintained between each second molding portion 111 and the corresponding fourth molding portion 121. The first and third molding portions 112, 122 are configured for molding central optical portions 202 of the lenses 200, and the second and fourth molding portions 111, 121 are configured for molding peripheral portions 201 of the lenses 200. That is, the chamber 130 can mold a plurality or even a multiplicity of lenses 200 in a single molding cycle.

One or more sprues (not shown) for injecting lens material into the chamber 130 can be defined in positions in the first mold core 110, or in positions adjacent to the chamber 130. For example, one sprue can be defined for each group of four adjacent first molding portions 112, with the sprue located in the first mold core 110 between the four first molding portions 112. In order to ensure quality of all the lenses 200 made at a same time, a length D1 of each of the first and third molding portions 112, 122 is preferably in a range from 1 millimeter to 1 centimeter, a minimum length D2 of each of the second and fourth molding portions 111, 121 between each two adjacent first and third molding portions 112, 122 is preferably in a range from 2 millimeters to 1 centimeter, the maximum space T1 between the first molding portions 112 and the third molding portions 122 is in a range from 1 millimeter to 1 centimeter, and the space T2 between the second molding portions 111 and the fourth molding portions 121 is in a range from 0.4 millimeters and 2 millimeters. That is, the chamber 130 is preferably used for molding a plurality of small sized lenses 200.

In a typical molding process using the mold 100, first, uncured lens material is injected into the chamber 130 at an injection rate of about 1000 millimeters per second or more. This high injection rate is to ensure that the entire chamber 130 can be fully filled with the lens material. Then, the lens material is cooled. Next, the first mold core 110 is separated from the second mold core 120, and the lens array 150 is ejected from second mold core 120. After that, the lens array 150 can be diced to obtain a plurality of discrete lenses 200.

The central optical portion 202 of each lens 200 in the lens array 150 has two convex surfaces 203, 204, which correspond to the first molding portion 112 and the third molding portion 122, respectively. For each two adjacent lenses 200, whether in a row or a column of the matrix, a part of the peripheral portion 201 of one of the lenses 200 is shared with a part of the peripheral portion 201 of the other lens 200. In this way, when the lens array 150 is diced at the peripheral portions 201, for example, the plurality of discrete lenses 200 can be obtained.

It is understood that the above-described embodiments are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A mold for molding a lens array comprising a plurality of lenses each of which has a central optical portion and a peripheral portion, the mold comprising:
a first mold core having a first molding surface, the first molding surface comprising a plurality of spaced first molding portions arranged in an array and a plurality of second molding portions, the first molding portions being interconnected by the second molding portions;
a second mold core having a second molding surface, the second molding surface comprising a plurality of spaced third molding portions arranged in an array and a plurality of fourth molding portions, the third molding portions being interconnected by the fourth molding portions;
wherein when the first mold core and the second mold core are in a molding position, the third molding portions are aligned with the first molding portions, the fourth molding portions are aligned with the second molding portions, a space is maintained between each first molding portion and the corresponding third molding portion, and a space is maintained between each second molding portion and the corresponding fourth molding portion, such that a chamber is defined between the first molding surface and the second molding surface, the first molding portions and the third molding portions being configured for cooperatively molding the central optical portions of the lenses, and the second molding portions and the fourth molding portions being configured for cooperatively molding the peripheral portions of the lenses.

2. The mold as described in claim 1, wherein each of the first and third molding portions is an item selected from the group consisting of concave surfaces and convex surfaces, and the second and fourth molding portions are flat surfaces.

3. The mold as described in claim 1, wherein the second molding portions are interconnected thereby cooperatively constituting a single, continuous surface, and the fourth molding portions are interconnected, thereby cooperatively constituting a single, continuous surface.

4. The mold as described in claim 1, wherein a length of each of the first and third molding portions is in a range from approximately 1 millimeter to approximately 1 centimeter, and a length of each of the second and fourth molding portions is in a range from approximately 2 millimeters to approximately 1 centimeter.

5. The mold as described in claim 1, wherein when the first mold core and the second mold core are in the molding position, a maximum value of the space between each first molding portion and the corresponding third molding portion is in a range from approximately 1 millimeter to approximately 1 centimeter, and the space between each second molding portion and the corresponding fourth molding portion is in a range from approximately 0.4 millimeters to approximately 2 millimeters.

6. A method for making a plurality of lenses, the method comprising:
providing a mold comprising a first mold core and a second mold core, the first mold core having a first molding surface, the first molding surface comprising a plurality of spaced first molding portions arranged in a line and a plurality of second molding portions, each two adjacent first molding portions being interconnected by a respective one of the second molding portions, the second mold core having a second molding surface, the second molding surface comprising a plurality of spaced third molding portions arranged in a line and a plurality of fourth molding portions, each two adjacent third molding portions being interconnected by a respective one of the fourth molding portions;
arranging the first mold core and second mold core close together by aligning the third molding portions with the first molding portions and aligning the fourth molding portions with the second molding portions while maintaining spaces between the third molding portions and the first molding portions and maintaining spaces between the fourth molding portions and the second molding portions, thereby defining a chamber between the first molding surface and the second molding surface;
injecting lens material into the chamber at an injection rate greater than or equal to about 1000 millimeters per second, the lens material filling the spaces between the third molding portions and the first molding portions and filling the spaces between the fourth molding portions and the second molding portions;
cooling the lens material;
separating the first and second mold cores to obtain a lens array, wherein the cooled lens material obtained from the spaces between the third molding portions and the first molding portions is central optical portions of lenses in the lens array, and the cooled lens material obtained from the spaces between the fourth molding portions and the second molding portions is peripheral portions of the lenses in the lens array; and
dicing the lens array at the peripheral portions to obtain discrete lenses.

7. The method as described in claim 6, wherein the first molding surface comprises a plurality of the lines of spaced first molding portions, the lines of spaced first molding portions cooperatively constituting an array having rows and columns of the first molding portions, and the second molding portions are interconnected thereby cooperatively constituting a single, continuous surface.

8. The method as described in claim 6, wherein the second molding surface comprises a plurality of the lines of spaced third molding portions, the lines of spaced third molding portions cooperatively constituting an array having rows and columns of the third molding portions, and the fourth molding portions are interconnected thereby cooperatively constituting a single, continuous surface.

9. A mold for molding a lens array comprising a plurality of lenses each of which has a central optical portion and a peripheral portion, the mold comprising:
a first mold core having a first molding surface, the first molding surface comprising a plurality of spaced first molding portions arranged in an array and a second molding portion, the first molding portions being interconnected by the second molding portion;
a second mold core having a second molding surface, the second molding surface comprising a plurality of spaced third molding portions arranged in an array and a fourth molding portion, the third molding portions being interconnected by the fourth molding portion;
wherein when the first molding surface and the second molding surface closely face each other in a molding position, the third molding portions are aligned with the first molding portions, the fourth molding portions are aligned with the second molding portions, a space is maintained between each first molding portion and the corresponding third molding portion, and a space is maintained between the second molding portion and the fourth molding portion, such that a molding cavity is defined between the first molding surface and the second molding surface, the first molding portions and the third molding portions cooperatively shaped to mold the central optical portions of the lenses, and the second molding portions and the fourth molding portions cooperatively shaped to mold the peripheral portions of the lenses.

10. The mold as described in claim 9, wherein each of the first and third molding portions is an item selected from the group consisting of concave surfaces and convex surfaces, and the second and fourth molding portions are flat surfaces.

11. The mold as described in claim 9, wherein the second and fourth molding portions each are a single, continuous surface.

12. The mold as described in claim 9, wherein a length of each of the first and third molding portions is in a range from approximately 1 millimeter to approximately 1 centimeter, and a length of each of the second and fourth molding portions is in a range from approximately 2 millimeters to approximately 1 centimeter.

13. The mold as described in claim 9, when the first mold core and the second mold core are in the molding position, a maximum value of the space between each first molding portion and the corresponding third molding portion is in a range from approximately 1 millimeter to approximately 1 centimeter, and the space between the second molding portion and the fourth molding portion is in a range from approximately 0.4 millimeters to approximately 2 millimeters.
